(19) United States
(12) Patent Application Publication
(10) Pub. No.: US 2014/0313912 A1
(43) Pub. Date: Oct. 23, 2014

(54) Configuration of Interference Averaging for Channel Measurements

(71) Applicant: TELEFONAKTIEBOLAGET L M ERICSSON (PUBL), Stockholm (SE)

(72) Inventors: George Jöngren, Sundbyberg (SE); Stefania Sesia, Roquefort Les Pins (FR)

(21) Appl. No.: 14/232,392

(22) PCT Filed: Oct. 17, 2013
(86) PCT No.: PCT/SE2013/051212

§ 371 Date: Jan. 13, 2014

Related U.S. Application Data
(60) Provisional application No. 61/757,525, filed on Jan. 28, 2013.

(51) Int. Cl. H04W 24/10

(52) U.S. Cl. CPC H04W 24/10
USPC 370/252

(57) ABSTRACT

The present disclosure relates to a method for determining CSI in a user terminal of a wireless communication network. The method comprises receiving (810) information from a network node indicating at least one of a plurality of different averaging schemes, and selecting (820) one of the averaging schemes based on the received information. The plurality of different averaging schemes each defines a limitation regarding over which radio resources that averaging is allowed for interference measurements. The method also comprises averaging (830) interference measurements using the selected averaging scheme, and determining (840) CSI for a CSI report based on the averaged interference measurements. The disclosure also relates to a method in a network node for controlling the averaging and to the user terminal and the network node.

### TECHNICAL FIELD

The present disclosure is generally related to the feedback of channel state information (CSI) in wireless communication systems and is more particularly related to a user terminal and a method for determining CSI as well as to a network node and a method for controlling averaging of interference measurements for determining CSI.

### BACKGROUND

The 3rd-Generation Partnership Project (3GPP) has developed a third-generation wireless communications known as Long Term Evolution (LTE) technology, as documented in the specifications for the Evolved Universal Terrestrial Radio Access Network (UTRAN). LTE is a mobile broadband wireless communication technology in which transmissions from base stations, referred to as eNodeBs or eNBs in 3GPP documentation, to user terminals referred to as user equipment (UE), in 3GPP documentation, are sent using orthogonal frequency division multiplexing (OFDM). OFDM splits the transmitted signal into multiple parallel sub-carriers in frequency.

The members of 3GPP are currently developing the Release 11 specifications for LTE. These developing standards will include specifications for yet another technology for extending high throughput coverage, namely improved support for Coordinated Multipoint (CoMP) transmission/reception, where multiple nodes coordinate transmissions and receptions to increase received signal quality and reduce interference.

CoMP transmission and reception refers to a system where the transmission and/or reception at multiple, geographically separated antenna sites is coordinated in order to improve system performance. More specifically, the term CoMP refers to the coordination of antenna arrays that have different geographical coverage areas. In the subsequent discussion an antenna covering a certain geographical area is referred to as a point, or more specifically as a Transmission Point (TP). The coordination can either be distributed, by means of direct communication between the different sites, or by means of a central coordinating node.

CoMP is a tool introduced in LTE to improve the coverage of high data rate services, to increase cell-edge throughput, and/or to increase system throughput. In particular, the goal is to distribute the user-perceived performance more evenly in the network by taking control of the interference. CoMP operation targets many different deployments, including coordination between sites and sectors in cellular macro deployments, as well as different configurations of heterogeneous deployments, where, for instance, a macro node coordinates its transmission with pico nodes within the macro coverage area.

### Some Basics of LTE on the Physical Layer

LTE uses OFDM in the downlink and Discrete Fourier Transform (DFT)-spread OFDM in the uplink. The basic LTE physical resource can thus be seen as a time-frequency grid as illustrated in FIG. 1, illustrating a portion of the available spectrum of an exemplary OFDM time-frequency resource grid 50 for LTE. Generally speaking, the time-frequency resource grid 50 is divided into one millisecond subframes in time. As shown in FIG. 3, each subframe 250 includes a number of OFDM symbols 230. For a normal cyclic prefix (CP) length, which is suitable for use in situations where multipath dispersion is not expected to be extremely severe, a subframe consists of fourteen OFDM symbols. A subframe has only twelve OFDM symbols if an extended cyclic prefix is used. In the frequency domain, the physical resources are divided into adjacent subcarriers 220 with a spacing of 15 kHz. The number of subcarriers 220 varies according to the allocated system bandwidth. The smallest element of the time-frequency resource grid 50 is a resource element (RE) 210. An RE consists of one OFDM subcarrier during one OFDM symbol interval.

LTE REs are grouped into resource blocks (RBs), each of which in its most common configuration consists of twelve subcarriers and seven OFDM symbols, also referred to as one slot 260. Thus, a RB typically consists of 84 REs. The two RBs occupying the same set of twelve subcarriers in a given radio subframe 250, which comprises two slots 260, are referred to as an RB pair, which includes 168 REs if a normal CP is used. Thus, an LTE radio subframe 270 is composed of multiple RB pairs in frequency with the number of RB pairs determining the bandwidth of the signal. In the time domain, LTE downlink transmissions are organized into radio frames 270 of 10 ms, each radio frame 270 consisting of ten equally-sized subframes 250 of length Tsubframe=1 ms. This is shown in FIG. 2.

The signal transmitted by an eNB to one or more UEs may be transmitted from multiple antennas. Likewise, the signal may be received at a UE that has multiple antennas. The radio channel between the eNB distorts the signals transmitted from the multiple antenna ports. To successfully demodulate downlink transmissions, the UE relies on reference symbols (RS) that are transmitted on the downlink. Several of these RSs are illustrated in the resource grid 50 shown in FIG. 3. These RSs and their position in the time-frequency resource grid are known to the UE and hence can be used to determine channel estimates by measuring the effect of the radio channel on these symbols.

Transmissions in LTE are dynamically scheduled, meaning that the base station transmits control information in each subframe about which terminals' data is transmitted to and/or which terminals are granted uplink transmission resources, as well as the RBs to be used for the data transmissions. The dynamic scheduling information is communicated to the UEs via the Physical Downlink Control Channel (PDCCH), which is transmitted in the control region. After successful decoding of a PDCCH, the UE performs reception of the Physical Downlink Shared Channel (PDSCH) or transmission of the Physical Uplink Shared Channel (PUSCH) according to pre-determined timing specified in the LTE specifications.

LTE uses hybrid automatic repeat request (HARQ), where, after receiving downlink data in a subframe, the terminal attempts to decode it and reports to the base station whether the decoding was successful (ACK) or not (NACK) via the Physical Uplink Control Channel (PUCCH). In case of an unsuccessful decoding attempt, the base station can retransmit the erroneous data. Similarly, the base station can indicate to the UE whether the decoding of the PUSCH was successful (ACK) or not (NACK) via the Physical HARQ Indicator Channel (PHICH). In addition to the PDCCH, the control region in the downlink signal from the base station thus also contains the PHICH.

The downlink Layer 1/Layer 2 (L1/L2) control signaling transmitted in the control region thus consists of the following different physical-channel types:

The Physical Control Format Indicator Channel (PCFICH), informing the terminal about the size of the control region 280—one, two, or three OFDM symbols. There is one and only one PCFICH on each component carrier or, equivalently, in each cell.

The PDCCH, used to signal downlink scheduling assignments and uplink scheduling grants. Each PDCCH typically carries signaling for a single terminal, but can also be used to address a group of terminals. Multiple PDCCHs can exist in each cell.

The PHICH, used to signal HARQ acknowledgements in response to uplink UL-SCH transmissions. Multiple PHICHs can exist in each cell.

The PDCCH is used to carry downlink control information (DCI) such as scheduling decisions and power-control commands. More specifically, the DCI includes:
Downlink scheduling assignments, including PDSCH resource indication, transport format, HARQ information, and control information related to spatial multiplexing if applicable. A downlink scheduling assignment also includes a command for power control of the PUCCH used for transmission of HARQ acknowledgements in response to downlink scheduling assignments.
Uplink scheduling grants, including PUSCH resource indication, transport format, and HARQ-related information. An uplink scheduling grant also includes a command for power control of the PUSCH.
Power-control commands for a set of terminals as a complement to the commands included in the scheduling assignments/grants.

One PDCCH carries one DCI message with one of the formats above. Since multiple terminals can be scheduled simultaneously, on both downlink and uplink, there must be a possibility to transmit multiple scheduling messages within each subframe. Each scheduling message is transmitted on a separate PDCCH, and consequently there are typically multiple simultaneous PDCCH transmissions within each cell. Furthermore, to support different radio-channel conditions, link adaptation can be used, where the code rate of the PDCCH is selected to match the radio-channel conditions.

Demodulation of received data by a receiver requires estimation of the radio channel. This estimation is done by using transmitted RSs, i.e. symbols known to the receiver. In LTE, cell-specific RSs (CRS) are transmitted in all downlink subframes. In addition to their use in downlink channel estimation, the CRS are also used for mobility measurements performed by the UEs. LTE also supports UE-specific RS, which are generally intended only for assisting channel estimation for demodulation purposes.

As noted above, FIG. 3 illustrates how the mapping of physical control/data channels and signals can be done on REs within a downlink subframe. In this example, the PDCCHs occupy the first out of three possible OFDM symbols, the so called control signaling region 280, so in this particular case the mapping of data could start already at the second OFDM symbol. Since the CRS is common to all UEs in the cell, the transmission of CRS cannot be easily adapted to suit the needs of a particular UE.

As previously indicated, CRS are not the only RSs available in LTE. As of LTE Release-10, new RSs were introduced, with separate UE-specific RS for demodulation of PDSCH and special RS for measuring the channel for the purpose of CSI feedback from the UE. The former are referred to as UE-specific RS, where each UE has RS of its own placed in the data region of FIG. 3, comprising the blank REs in the figure, as part of PDSCH. The latter RSs are referred to as CSI-RS. CSI-RS are not transmitted in every subframe and they are generally sparser in time and frequency than RS used for demodulation. CSI-RS transmissions may occur every 5^{th}, 10^{th}, 20^{th}, 40^{th}, or 80^{th} subframe according to an RRC configured periodicity parameter and an RRC configured subframe offset.

A UE operating in connected mode can be requested by the base station to perform CSI reporting, e.g. reporting a suitable rank indicator (RI), one or more precoding matrix indices (PMIs) and a channel quality indicator (CQI). Other types of CSI are also conceivable, including explicit channel feedback and interference covariance feedback. The CSI feedback assists the base station in scheduling, including deciding the subframe and RBs for the transmission, which transmission scheme/precoder to use, as well as provides information on a proper user bit rate for the transmission, called link adaptation. In LTE, both periodic and aperiodic CSI reporting is supported. In the case of periodic CSI reporting, the terminal reports the CSI measurements on a configured periodical time basis on the PUCCH, whereas with aperiodic reporting the CSI feedback is transmitted on the PUSCH at pre-specified time instants after receiving the CSI grant from the base station. With aperiodic CSI reports, the base station can thus request CSI reflecting downlink radio conditions in a particular subframe.

A detailed illustration of which REs within a RB pair that may potentially be occupied by UE specific RS, also referred to as Demodulation RS (DMRS), and CSI-RS is provided in FIG. 4. The CSI-RS are marked with a number corresponding to the CSI-RS antenna port. The CSI-RS utilizes an orthogonal cover code of length two to overlay two antenna ports on two consecutive REs. As seen, many different CSI-RS pattern are available. For the case of 2 CSI-RS antenna ports we see that there are 20 different patterns within a subframe. The corresponding number of patterns is 10 and 5 for 4 and 8 CSI-RS antenna ports, respectively. For TDD, some additional CSI-RS patterns are available.

Subsequently, the term CSI-RS resource may be mentioned. In such a case, a resource corresponds to a particular pattern present in a particular periodically occurring subframe, according to the configured period of the CSI-RS. Thus, two different patterns in the same subframe or the same CSI-RS pattern but in different subframes belonging to two different periodic versions in both cases constitute two separate CSI-RS resources.

The CSI-RS patterns may also correspond to so-called zero-power (ZP) CSI-RS, also referred to as muted REs. ZP CSI-RS corresponds to a CSI-RS pattern whose REs are silent, i.e., there is no transmitted signal on those REs. Such silent patterns are configured with a resolution corresponding to the 4 antenna port CSI-RS patterns. Hence, the smallest unit to silence corresponds to four REs.

One purpose of ZP CSI-RS is to raise the SINR for CSI-RS in a cell by configuring ZP CSI-RS in interfering cells so that the REs otherwise causing the interference are silent. Thus, a CSI-RS pattern in a certain cell is matched with a corresponding ZP CSI-RS pattern in interfering cells. Raising the signal to interference and noise relation (SINR) level for CSI-RS measurements is particularly important in applications such as CoMP or in heterogeneous deployments. In CoMP, the UE is likely to need to measure the channel from non-serving cells and interference from the much stronger serving cell would in that case be devastating. ZP CSI-RS is also needed in heterogeneous deployments where ZP CSI-RS in the macro-layer is configured so that it coincides with CSI-RS transmissions in the pico-layer. This avoids strong interference from macro nodes when UEs measure the channel to a pico node.

The PDSCH is mapped around the REs occupied by CSI-RS and ZP CSI-RS so it is important that both the network and the UE are assuming the same CSI-RS/ZP CSI-RS configuration or else the UE is unable to decode the PDSCH in subframes containing CSI-RS or their ZP counterparts.

In the uplink, so-called sounding RSs (SRS) may be used for acquiring CSI about the uplink channel from the UE to the receiving nodes. If SRS is used, it is transmitted on the last DFT spread OFDM symbol of a subframe. SRS can be configured for periodic transmission as well for dynamic triggering as part of the uplink grant. The primary use for SRS is to aid the scheduling and link adaptation in the uplink. But for TDD, SRS is sometimes used to determine beamforming weights for the downlink by exploiting the fact that the downlink and uplink channels are the same when the same carrier frequency is used for downlink and uplink (channel reciprocity).

While PUSCH carries data in the uplink, PUCCH is used for control. PUCCH is a narrowband channel using an RB pair where the two RBs are on opposite sides of the potential scheduling bandwidth. PUCCH is used for conveying ACK/NACKs, periodic CSI feedback, and scheduling request to the network.

Before an LTE terminal can communicate with an LTE network it first has to find and acquire synchronization to a cell within the network, i.e. performing cell search. Then it has to receive and decode system information needed to communicate with and operate properly within the cell, and finally access the cell by means of the so-called random-access procedure.

### Multi-Antenna Techniques and CSI Feedback

Multi-antenna techniques can significantly increase the data rates and reliability of a wireless communication system. The performance is particularly improved if both the transmitter and the receiver are equipped with multiple antennas, which results in a multiple-input multiple-output (MIMO) communication channel. Such systems and/or related techniques are commonly referred to as MIMO.

A core component in LTE is the support of MIMO antenna deployments and MIMO related techniques. For instance, in LTE there is support for a spatial multiplexing mode, which may possibly also utilize channel-dependent precoding. The spatial multiplexing mode is aimed for high data rates in favorable channel conditions. An illustration of the spatial multiplexing mode is provided in FIG. 5.

As seen, the information carrying symbol vector s is multiplied by an NT×r precoder matrix W_{N}_{_{T}}_{×r}, where NT is the number of antenna ports, which serves to distribute the transmit energy in a subspace of the NT dimensional vector space. The precoder matrix is typically selected from a codebook of possible precoder matrices, and typically indicated by means of a PMI, which specifies a unique precoder matrix in the codebook. If the precoder matrix is confined to have orthonormal columns, then the design of the codebook of precoder matrices corresponds to a Grassmannian subspace packing problem. The r symbols in symbol vector s each correspond to a layer and r is referred to as the transmission rank. In this way, spatial multiplexing is achieved since multiple symbols can be transmitted simultaneously over the same RE. The number of symbols r is typically adapted to suit the current channel properties.

LTE uses OFDM in the downlink and DFT precoded OFDM in the uplink and hence the received N_{R}×1 vector yₙ for a certain RE on subcarrier n, or alternatively data RE number n, assuming no inter-cell interference, is thus modeled by

yₙ=HₙW_{N}_{_{T}}_{×r}sₙ+eₙ

where eₙ is a noise and interference vector obtained as realizations of a random process. The precoder, W_{N}_{_{T}}_{×r} can be a wideband precoder, which is constant over frequency, or frequency selective.

The precoder matrix is often chosen to match the characteristics of the N_{R}×N_{T} MIMO channel H, resulting in so-called channel dependent precoding. This is also commonly referred to as closed-loop precoding and essentially strives for focusing the transmit energy into a subspace which is strong in the sense of conveying much of the transmitted energy to the UE. In addition, the precoder matrix may also be selected to strive for orthogonalizing the channel, meaning that after proper linear equalization at the UE, the inter-layer interference is reduced.

### CSI-RS

As noted above, in LTE Release-10, a new RS sequence, the CSI-RS, was introduced for use in estimating channel state information. The CSI-RS provides several advantages over basing the CSI feedback on the common RSs, CRS, which were used for that purpose in previous releases. Firstly, the CSI-RS is not used for demodulation of the data signal, and thus does not require the same density, i.e., the overhead of the CSI-RS is substantially less. Secondly, CSI-RS provides a much more flexible means to configure CSI feedback measurements, e.g., which CSI-RS resource to measure on can be configured in a UE specific manner. Moreover, the support of antenna configurations larger than four antennas must resort to CSI-RS, since the CRS is only defined for at the most four antennas.

By measuring on a CSI-RS, a UE can estimate the effective channel the CSI-RS is traversing including the radio propagation channel, antenna gains, and any possible antenna virtualizations. A CSI-RS port may be pre-coded so that it is virtualized over multiple physical antenna ports; that is, the CSI-RS port can be transmitted on multiple physical antenna ports, possibly with different gains and phases. In more mathematical rigor this implies that if a known CSI-RS signal xₙ is transmitted, a UE can estimate the coupling between the transmitted signal and the received signal, i.e., the effective channel. Hence if no virtualization is performed in the transmission, the received signal yₙ can be expressed as

yₙ=Hₙxₙ+eₙ

and the UE can estimate the effective channel H_{eff}=Hₙ. Similarly, if the CSI-RS is virtualized using a precoder W_{N}_{_{T}}_{×r} as

yₙ=HₙW_{N}_{_{T}}_{×r}xₙ+eₙ

then the UE can estimate the effective channel H_{eff}=HₙW_{N}_{_{T}}_{×r}.

As previously mentioned, related to CSI-RS is the concept of ZP CSI-RS resources, also known as a muted CSI-RS, that are configured just as regular CSI-RS resources so that a UE knows that the data transmission is mapped around those resources. The original intent of the ZP CSI-RS resources is to enable the network to mute the transmission on the corresponding resources in order to boost the SINR of a corresponding non-ZP CSI-RS, possibly transmitted in a neighbor cell/TP.

For Rel-11 of LTE, ZP CSI-RS may also be exploited for interference measurement purposes. Special so-called interference measurements resources (IMR) are introduced, which the UE uses for measuring interference plus noise. Another name for IMR used in the LTE specifications is CSI-IM. A UE can assume that only interfering TPs are transmitting on the ZP CSI-RS resource, and the received power can therefore be used as a measure of the interference plus noise. To avoid that the transmissions intended to the UE are erroneously counted as interference, the PDSCH of the UE needs to be mapped around the IMRs. This can be done by configuring ZP CSI-RS to coincide with the IMRs in use. For this reason, the set of REs used for IMR(s) can be used for ZP CSI-RS and vice-versa.

Based on a specified CSI-RS resource and on an interference measurement configuration (e.g. a ZP CSI-RS resource), the UE can estimate the effective channel and noise plus interference, and consequently also determine the transmission rank, pre-coder, and transport format to recommend that best match the particular channel.

### Implicit CSI Feedback

For CSI feedback, LTE has adopted an implicit CSI mechanism where a UE does not explicitly report, for example, the complex valued elements of a measured effective channel. Rather, the UE recommends a transmission configuration for the measured effective channel. The recommended transmission configuration thus implicitly gives information about the underlying channel state.

In LTE, the CSI feedback is given in terms of a transmission RI, a PMI, and a CQI. The CQI/RI/PMI report can be wideband or frequency selective depending on which reporting mode that is configured.

The RI corresponds to a recommended number of streams that are to be spatially multiplexed and thus transmitted in parallel over the effective channel. The PMI identifies a recommended pre-coder in a codebook for the transmission, which relates to the spatial characteristics of the effective channel. The CQI represents a recommended transport block size, i.e., code rate. There is thus a relation between a CQI and a SINR of the spatial stream(s) over which the transport block is transmitted.

### CoMP

There are many different CoMP transmission schemes that are considered; for example,

Dynamic Point Blanking where multiple TPs coordinate the transmission so that neighboring TPs may mute the transmissions on the time-frequency resource elements (TFREs) that are allocated to UEs that experience significant interference.

Dynamic Point Selection where the data transmission to a UE may switch dynamically in time and frequency between different TPs, so that the TPs are fully utilized.

Coordinated Beamforming where the TPs coordinate the transmissions in the spatial domain by beamforming the transmission power in such a way that the interference to UEs served by neighboring TPs are suppressed.

Joint Transmission where the signal to a UE is simultaneously transmitted from multiple TPs on the same time/frequency resource. The aim of joint transmission is to increase the received signal power and/or reduce the received interference, if the cooperating TPs otherwise would serve some other UEs without taking our joint transmission UE into consideration.

### CoMP Feedback

A common denominator for the CoMP transmission schemes is that the network needs CSI information not only for the serving TP, but also for the channels linking the neighboring TPs to a terminal. By, for example, configuring a unique CSI-RS resource per TP, a UE can resolve the effective channels for each TP by measurements on the corresponding CSI-RS. A CSI-RS resource can loosely be described as the pattern of REs on which a particular CSI-RS configuration is transmitted. A CSI-RS resource is determined by a combination of “resourceConfig”, “subframeConfig”, and “antennaPortsCount”, which are configured by RRC signaling. It should be noted that the UE is likely unaware of the physical presence of a particular TP, it is only configured to measure on a particular CSI-RS resource, without knowing of any association between the CSI-RS resource and a TP.

CoMP feedback for LTE Rel 11 builds upon per CSI-RS resource feedback which corresponds to separate reporting of CSI for each of a set of CSI-RS resources. Such a CSI report could for example correspond to a PMI, RI, and/or CQI, which represent a recommended configuration for a hypothetical downlink transmission over the same antennas used for the associated CSI-RS, or as the RS used for the channel measurement. More generally, the recommended transmission should be mapped to physical antennas in the same way as the RSs used for the CSI channel measurement. Potentially, there could be interdependencies between the CSI reports; for example, they could be constrained to have the same RI, so-called rank inheritance.

Typically there is a one-to-one mapping between a CSI-RS and a TP, in which case per CSI-RS resource feedback corresponds to per-TP feedback; that is, a separate PMI/RI/CQI is reported for each TP.

The considered CSI-RS resources are configured by the eNodeB as the CoMP Measurement Set.

### Interference Measurements for CoMP

For efficient CoMP operation it is as important to capture appropriate interference assumptions when determining the CQIs as it is to capture the appropriate received desired signal.

In uncoordinated systems the UE can effectively measure the interference observed from all other TPs or all other cells, which will be the relevant interference level in an upcoming data transmission. In releases prior to Rel-11, such interference measurements are typically performed by analyzing the residual interference on CRS resources after the UE subtracts the impact of the CRS signal.

In coordinated systems performing CoMP, such interference measurements become increasingly irrelevant. Most notably, within a coordination cluster an eNodeB can to a large extent control which TPs interfere with a UE in any particular TFRE. Hence, there will be multiple interference hypotheses, each depending on which TPs are transmitting data to other terminals.

### Interference Measurement Resource (IMR)

For the purpose of improved interference measurements, new functionality is introduced in LTE Release 11. There, the agreement is that the network will be able to configure a UE to measure interference on a particular IMR, which identifies a particular set of REs in the time and frequency grid that is to be used for a corresponding interference measurement. The network can thus control the interference seen on an IMR, by, for example, muting all TPs within a coordination cluster on the IMR, in which case the UE will effectively measure the inter-CoMP cluster interference. Moreover, it is essential that an eNodeB can accurately evaluate the performance of a UE given different CoMP transmission hypotheses. Otherwise the dynamic coordination becomes meaningless. Thus, the system must also be able to track/estimate different intra-cluster interference levels corresponding to different transmission and blanking hypotheses.

Taking, for example, a dynamic point blanking scheme as illustrated in FIG. 6, where TP1 and TP2 form a coordination cluster. From the perspective of the illustrated UE there will exist two relevant interference hypotheses: In one interference hypothesis the UE 60 sees no interference from the coordinated neighboring TP2, since it is muted, and hence the UE will only experience the signal from its serving point, TP1. In the second hypothesis the UE sees interference from the neighboring point, TP2, as well as the signal from its serving point TP1. To enable the network to effectively determine whether or not a TP should be muted in this example, the UE can report two, and for a general case multiple, CQIs corresponding to the different interference hypotheses. One way to generate these multiple CQIs would be to configure a set of IMRs as shown in Table 1 illustrating the IMR configuration for the example in FIG. 6, where “1” represents that the TP is transmitting, and “0” represents that the TP is muted. The first IMR corresponds to the first mentioned hypothesis mentioned above, i.e., no interference from TP2 with the implicit assumption that the desired signal originates from the TP1. It should be noted that the desired signal hypothesis is not handled by the configuration of IMRs but rather the configuration of what CSI-RS to use as the source of the desired signal. The second IMR corresponds to the second hypothesis. Finally, there is also a third IMR defined but this one is of no interest for the illustrated UE. Since TP1 is the serving TP it is not interesting to consider it as interference. The system can therefore configure the UE to only measure and report CSI feedback based on IMR numbers 1-2. The example illustrates the principle of selecting relevant IMRs for the dynamic point blanking CoMP scheme, for which only IMRs that are muted in the serving TP is of relevance. For other CoMP schemes, in particular dynamic point switching, IMRs representing interference from the serving TP could also be of interest.

TABLE 1
IMR configuration

| IMR | TP1 | TP2 |
|---|---|---|
| 1 | 0 | 0 |
| 2 | 0 | 1 |
| 3 | 1 | 0 |

### CSI Processes

As previously mentioned, the CSI feedback relies on measurements of a channel part, based on e.g. CSI-RS, and on an interference plus noise part. In Rel-11, these two parts are collected into an entity referred to as CSI process. Thus, a CSI process is associated with a certain CSI-RS resource typically corresponding to a TP and an IMR. According to LTE specifications, the number of CSI processes that a UE uses is configurable from one to four and for each CSI process it is configurable which IMR and which CSI-RS resource to use. Hence, two different CSI processes may use two different CSI-RS resources typically corresponding to two different TPs or they may use two different IMRs so as to cover different interference hypotheses, or a combination thereof.

A CSI report typically corresponds to the CSI transmitted in a certain subframe for a certain CSI process using a certain CSI feedback mode. A CSI report is associated to a CSI process and the CSI process is in turn associated with an IMR. An IMR consists of multiple REs typically occurring in every N:th subframe in every RB in the frequency domain. The interference estimate for a CSI report in the UE may only be formed based on the REs within the relevant IMR. A CSI entity within a CSI report is supposed to reflect some property of the communication link where both channel part and noise plus interference parts are included at a certain subframe at certain frequencies and at certain layer(s). This is referred to as the CSI reference resource; details can be found in Section 7.2.3 of 3GPP TS 36.213, “Physical Layer Procedures,” v11.1.0 (December 2012).

The choice of CSI-RS resource and IMR are not the only parameters signaled as part of the configuration of a CSI process. For a more detailed description of the information elements contained in a CSI process, see 3GPP TS 36.331, “Radio Resource Control (RRC),” v. 11.2.0 (January 2013). The maximum number of supported CSI processes is a UE capability, so some UEs may very well support fewer than four processes.

For CoMP operation, it may be useful to configure more than one CSI process so that the CSI feedback can reflect CSI corresponding to links to different TPs and/or different interference hypotheses, while for conventional no-CoMP operation, the configuration of a single CSI process appears sufficient.

### SUMMARY

A problem with existing solutions is that there are no specifications governing how the UE should measure or estimate interference, except that the UE shall do so using the IMR REs in the event that Transmission Mode 10 (TM10) is configured. Lack of specifications for other transmission modes, such as Transmission Modes 1-9 (TM1-9), is even more serious. There is in general a belief that UEs use CRS REs for interference estimation in TM1-9. In practice, some UEs form an estimate based on many subframes in time and many RBs in frequency, while other UEs may use only a single subframe and a single frequency subband. This leads to an inconsistent UE behavior that makes it more difficult to tune the network for efficient system operation. For example, letting the interference estimate reflect an average interference level over a large time-frequency region means that the network loses the ability to see the consequences of dynamically changing behavior.

Largely unspecified UE interference measurement or estimation behaviour also creates problems for CoMP, which relies upon accurate knowledge of which interfering transmission or transmissions that are part of or form the basis for a CSI report. With an unspecified or a badly specified interference measurement mechanism, the network cannot be certain what transmissions that are contributing to a received CSI report, hence blurring the network's knowledge about interference impact.

It is therefore an object to address some of the problems outlined above, and to provide a solution for control of averaging of interference measurements used by a user terminal for determining CSI. This object and others are achieved by the methods, the user terminal and the network node according to the independent claims, and by the embodiments according to the dependent claims.

In accordance with a first aspect, a method for determining CSI in a user terminal of a wireless communication network is provided. The method comprises receiving information from a network node, the information indicating at least one of a plurality of different averaging schemes. Each averaging scheme within the plurality of different averaging schemes defines a limitation regarding over which radio resources averaging is allowed for interference measurements. The method also comprises selecting one of the plurality of different averaging schemes based on the received information. Furthermore, the method comprises averaging interference measurements using the selected one of the plurality of different averaging schemes, and determining CSI for a CSI report based on the averaged interference measurements.

In accordance with a second aspect, a method for controlling averaging of interference measurements is provided. The method is suitable for implementation in a network node of a wireless communication network. The method comprises transmitting a message to a user terminal. The message indicates at least one of a plurality of different averaging schemes chosen by the network node, to control the averaging of interference measurements performed by the user terminal when determining CSI. Each averaging scheme within the plurality of different averaging schemes defines a limitation regarding over which radio resources averaging is allowed for interference measurements.

In accordance with a third aspect, a user terminal of a wireless communication network for determining CSI is provided. The user terminal comprises a receiver, a processor, and a memory, said memory containing instructions executable by said processor whereby said user terminal is operative to receive information from a network node via the receiver, the information indicating at least one of a plurality of different averaging schemes, select one of the plurality of different averaging schemes based on the received information, average interference measurements using the selected one of the plurality of different averaging schemes, and determine CSI for a CSI report based on the averaged interference measurements. Each averaging scheme within the plurality of different averaging schemes defines a limitation regarding over which radio resources averaging is allowed for interference measurements.

In accordance with a fourth aspect, a network node of a wireless communication network for controlling averaging of interference measurements is provided. The network node comprises a communication unit, a processor, and a memory, said memory containing instructions executable by said processor whereby said network node is operative to transmit a message via the communication unit to a user terminal. The message indicates at least one of a plurality of different averaging schemes chosen by the network node, to control the averaging of interference measurements performed by the user terminal when determining CSI. Each averaging scheme within the plurality of different averaging schemes defines a limitation regarding over which radio resources averaging is allowed for interference measurements.

In accordance with a fifth aspect, a user terminal of a wireless communication network for determining CSI is provided. The user terminal comprises means for receiving information from a network node, the information indicating at least one of a plurality of different averaging schemes. Each averaging scheme within the plurality of different averaging schemes defining a limitation regarding over which radio resources averaging is allowed for interference measurements. The user terminal also comprises means for selecting one of a plurality of different averaging schemes based on the received information, means for averaging interference measurements using the selected one of the plurality of different averaging schemes, and means for determining CSI for a CSI report based on the averaged interference measurements.

In accordance with a sixth aspect, a network node of a wireless communication network for controlling averaging of interference measurements is provided. The network node comprises means for transmitting a message to a user terminal. The message indicates at least one of a plurality of different averaging schemes chosen by the network node, to control the averaging of interference measurements performed by the user terminal when determining CSI. Each averaging scheme within the plurality of different averaging schemes defines a limitation regarding over which radio resources averaging is allowed for interference measurements.

An advantage of embodiments is that an adjustment of the amount of interference averaging that the UE performs for determining CSI is allowed, such that the averaging corresponds to what is suitable for the situation at hand.

Another advantage of embodiments is that the network is allowed to control the averaging of interference measurements e.g. depending on the scheduling strategy of the network.

A further advantage is that inconsistent behavior of UEs operating in the same network with regards to interference averaging is reduced or removed, hence allowing for optimized setup of outer-loop-link adaptation control, and thus ensuring high performance.

Other objects, advantages and features of embodiments will be explained in the following detailed description when considered in conjunction with the accompanying drawings and claims.

### BRIEF DESCRIPTION OF THE DRAWINGS

FIG. 1 is a schematic illustration of the time frequency grid in LTE.

FIG. 2 is a schematic illustration of an LTE radio frame.

FIG. 3 is a schematic illustration of the mapping of physical control/data channels and signals on resource elements within a downlink subframe.

FIG. 4 is a schematic illustration of a resource element grid for an RB pair showing potential positions for Rel-9/10 DMRS, CSI-RS, and CRS.

FIG. 5 is a schematic illustration of a spatial multiplexing mode.

FIG. 6 is a schematic illustration of dynamic point blanking for a coordination cluster.

FIG. 7 is a schematic illustration of a simplified exemplary mobile communication network.

FIG. 8 is a flowchart illustrating the method in a user terminal according to embodiments.

FIG. 9 is a flowchart illustrating the method in a network node according to embodiments.

FIGS. 10a-b are block diagrams schematically illustrating apparatus according to embodiments.

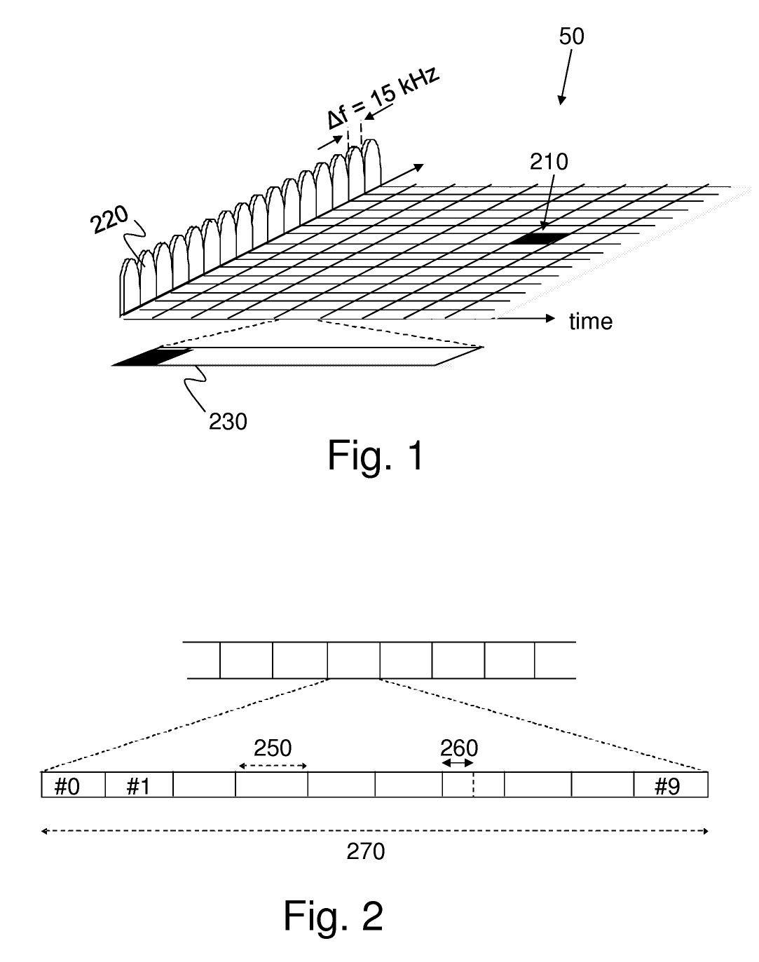

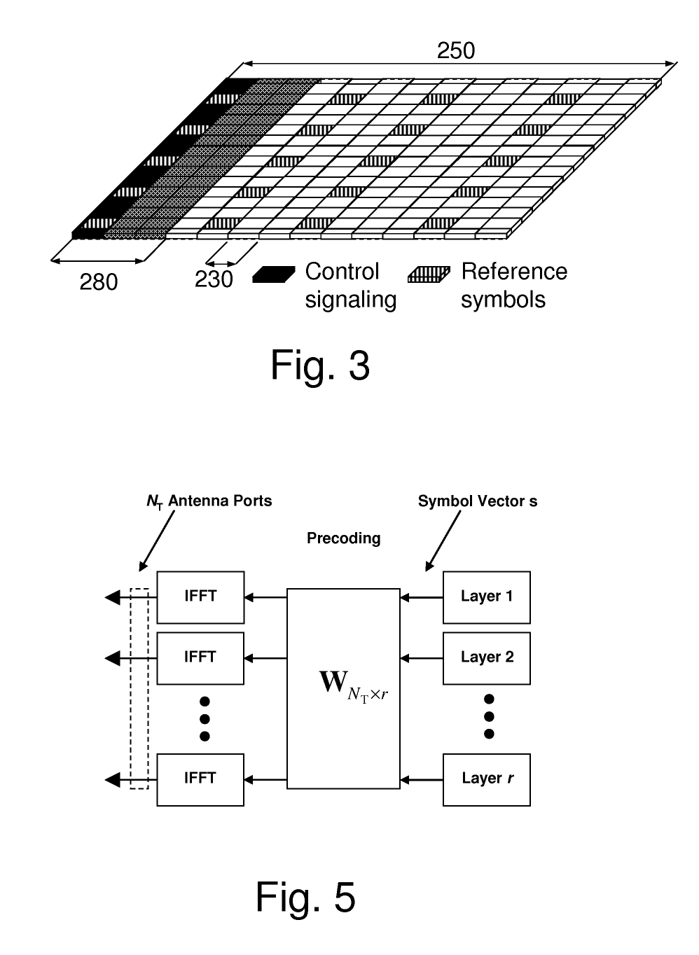

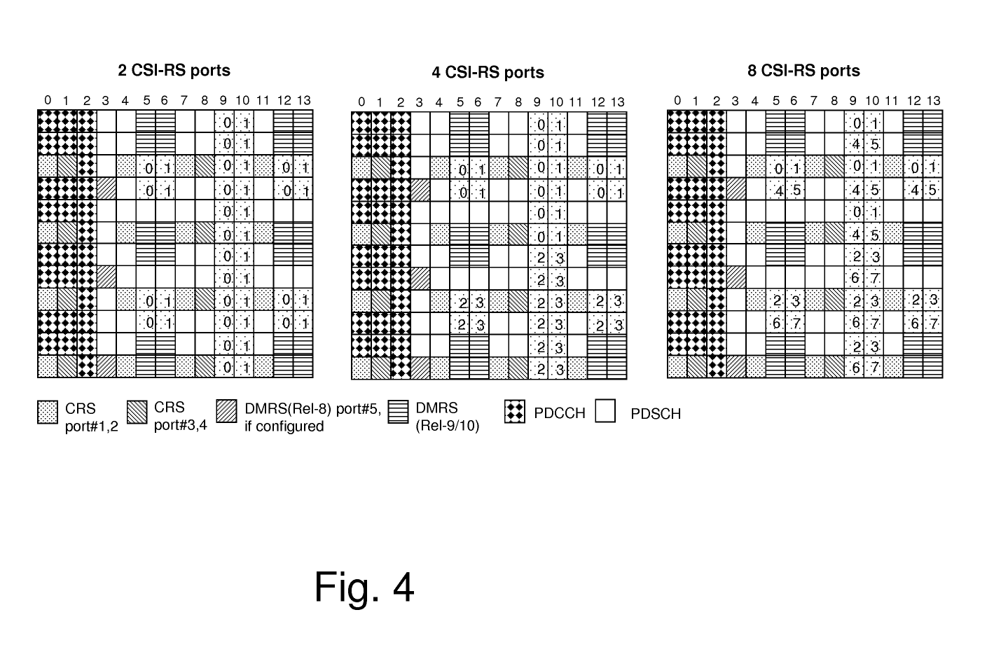

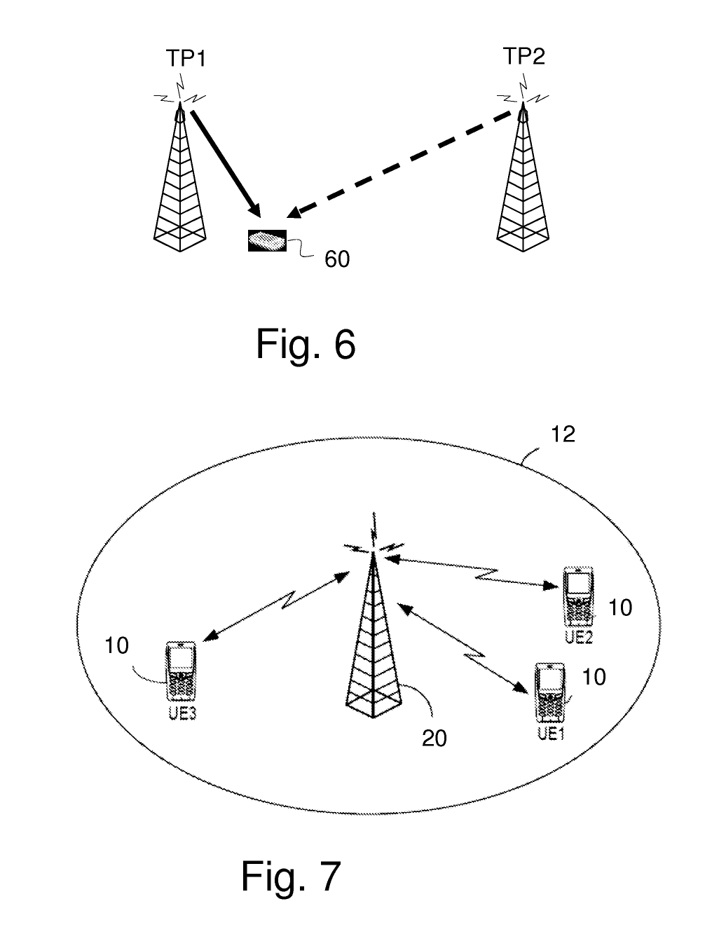

### DETAILED DESCRIPTION

### Introduction

In the discussion that follows, specific details of particular embodiments of the presently disclosed techniques and apparatus are set forth for purposes of explanation and not limitation. It will be appreciated by those skilled in the art that other embodiments may be employed apart from these specific details. Furthermore, in some instances detailed descriptions of well-known methods, nodes, interfaces, circuits, and devices are omitted so as not to obscure the description with unnecessary detail. Those skilled in the art will appreciate that the functions described may be implemented in one or in several nodes. Some or all of the functions described may be implemented using hardware circuitry, such as analog and/or discrete logic gates interconnected to perform a specialized function, ASICs, PLAs, etc. Likewise, some or all of the functions may be implemented using software programs and data in conjunction with one or more digital microprocessors or general purpose computers. Where nodes that communicate using the air interface are described, it will be appreciated that those nodes also have suitable radio communications circuitry. Moreover, the technology can additionally be considered to be embodied entirely within any form of computer-readable memory, including non-transitory embodiments such as solid-state memory, magnetic disk, or optical disk containing an appropriate set of computer instructions that would cause a processor to carry out the techniques described herein.

Hardware implementations may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

Referring now to the drawings, FIG. 7 illustrates a simplified view of an exemplary mobile communication network for providing wireless communication services to user terminals 10. Three user terminals 10, which are referred to as UEs in LTE terminology, are shown in FIG. 7. The user terminals 10 may comprise, for example, cellular telephones, personal digital assistants, smart phones, laptop computers, handheld computers, or other devices with wireless communication capabilities. It should be noted that the terms “user terminal,” “mobile station,” or “mobile terminal,” as used herein, refer to a terminal operating in a mobile communication network and do not necessarily imply that the terminal itself is mobile or moveable. Thus, the terms should be understood as interchangeable for the purposes of this disclosure and may refer to terminals that are installed in fixed configurations, such as in certain machine-to-machine applications, as well as to portable devices, devices installed in motor vehicles, etc.

The mobile communication network comprises a plurality of geographic cell areas or sectors 12. Each geographic cell area or sector 12 is served by a base station 20, which is generally referred to in LTE as an Evolved NodeB (eNodeB or eNB). One base station 20 may provide service in multiple geographic cell areas or sectors 12. The user terminals 10 receive signals from base station 20 on one or more downlink channels, and transmit signals to the base station 20 on one or more uplink channels.

For illustrative purposes, several embodiments will be described in the context of an LTE system. Those skilled in the art will appreciate, however, that the presently disclosed techniques may be more generally applicable to other wireless communication systems, including, for example, WiMax (IEEE 802.16) systems.

### Overview of Embodiments

The problems related to inconsistent UE behavior with regards to averaging for interference measurements are addressed by a solution described herein making it possible for the network to change the amount of interference averaging performed by a UE, e.g. over the REs within the IMR that the UE is configured to use for determining a CSI report. In particular, the techniques detailed below deal with different ways for the network to signal to the UE what amount of interference averaging to use or what amount of interference averaging that the UE is maximally allowed to use. In some embodiments of the invention, the amount of averaging for a CSI report is inferred by the UE from one or more of the following:
the number of CSI processes used/configured for CSI feedback;
whether rank inheritance is configured or not;
which transmission mode is configured for the UE;
whether the CSI report is of type aperiodic or periodic;
the number of antenna ports configured for the CSI report;
whether PMI or no-PMI/RI reporting is configured for the CSI feedback mode;
the periodicity configured for the CSI feedback mode associated to the CSI report;
the configuration of Physical downlink shared channel mapping and Quasi co-location Information (PQI) in the downlink control channel;
explicit signaling from the eNodeB.

One way to change the amount of interference averaging is to let the network control the set of REs within which interference averaging is allowed/performed, i.e., the subset of REs over which averaging is allowed or performed within the IMR of interest. This constitutes an important special case of the described techniques.

Embodiments of the invention described herein include methods suitable for implementation in a user terminal. An example method comprises selecting one of a plurality of averaging schemes to be used for averaging interference measurements, and determining a CSI report based on the selected averaging scheme. In some embodiments, there may be only two averaging schemes, e.g., averaging amount A and averaging amount B, but other embodiments may provide for more than two.

One or more of the averaging schemes may be applicable to only the averaging of IMR REs, in some embodiments. In other embodiments, the averaging scheme may be alternatively applicable to other RSs, or additionally applicable to other RSs. In some embodiments, the applicability of the averaging scheme to RSs may depend on the transmission mode, such as whether or not the user terminal is using Transmission Mode 10 as specified by the LTE specifications.

In several embodiments, the selecting of the averaging scheme is based on configuration information. The configuration information may be signaled to the user terminal by the network. For example, in some embodiments, the averaging scheme is selected based on whether or not CoMP is used. Thus, for example, a first averaging scheme is used if CoMP is used, while a second averaging scheme is used otherwise. In some of these embodiments, the averaging scheme used when CoMP is used may confine the averaging scheme to RSs in a single subframe, or to within a particular subband, while the averaging scheme used otherwise may comprise averaging across several subframes and/or across a larger subband. In some embodiments, the selecting of the averaging scheme is based on the transmission mode used by the user terminal. For instance, a first averaging scheme may be selected for transmission modes 1 to 9, while a second averaging scheme is selected for transmission mode 10. Similarly, the selected averaging scheme may depend on the number of antenna ports assumed for the report in some embodiments. Likewise, the averaging scheme may depend on the configuration of PMI reporting, and/or on the configuration of PQI. In some embodiments, the averaging scheme may depend on whether TDD or FDD mode is being used. In some embodiments, the selecting of the averaging scheme may depend on the number of CSI processes that the user terminal is configured to use. In some embodiments, the selecting of the averaging scheme may depend on whether or not rank inheritance is configured for at least one CSI process. In some embodiments, the user terminal may apply different averaging schemes to different CSI processes, e.g., depending on whether or not rank inheritance is configured for each process. In some embodiments, the user terminal may apply different averaging schemes to different CSI processes, where the selection of the averaging scheme for a given CSI process depends on an index for the process. In still other embodiments, the selecting of the averaging scheme may depend on the type of CSI report, such as whether the CSI report is a periodic or aperiodic. Thus, for example, a first averaging scheme may be used for periodic reports, while a second averaging scheme is used for aperiodic reports. Similarly, in some embodiments the selecting of the averaging scheme may depend on the length of the period for periodic CSI reporting. More details regarding the choice of averaging scheme based on configuration information is provided below.

It will be appreciated that the selecting of the averaging scheme may depend on a combination of two or more of the configuration parameters described above, or a combination of any of the above parameters with one or more other parameters. Furthermore, in some embodiments the user terminal may base the selection of the averaging scheme on explicit signaling from the network, alone or in combination with one or more of the configuration parameters described above. The explicit signaling may indicate a particular amount of averaging to use, in some embodiments, e.g., in terms of particular REs to be used and/or in terms of a number of subframes and/or a quantity of frequency resources to be used for such averaging. In some embodiments, the user terminal may be configured to select an averaging scheme based on one or more of the configuration parameters described above in the absence of explicit signaling, while following the explicit signaling when it is present.

Other embodiments of the techniques described below comprise corresponding methods suitable for implementation in a network node such as a base station or other controlling node in a wireless communication system. In an example method, the base station or other controlling network node chooses one of a plurality of averaging schemes to be used for averaging interference measurements by a given user terminal, and transmits signaling information indicating the chosen averaging scheme to the user terminal. In some embodiments, there may be only two averaging schemes, e.g., averaging amount A and averaging amount B, but other embodiments may provide for more than two.

In various embodiments, the choosing of the averaging scheme by the base station or other controlling network node may be based on one or more of the configuration parameters discussed above. In some embodiments, the choosing of the averaging scheme may be based on one or more network conditions or traffic conditions, such as a network load, traffic burstiness, packet length, and/or packet arrival rate, or on user terminal mobility. The choosing of the averaging scheme may be based on a combination of two or more of these conditions and/or a combination of one or more of these conditions with one or more of the configuration parameters mentioned above, in some embodiments.

Corresponding apparatus embodiments adapted to carry out these methods, i.e., UE/user terminal apparatus, base station (e.g., eNodeB) apparatus, and control network node apparatus, follow directly from the above and are described in detail below. Of course, the techniques and apparatus described herein are not limited to the above-summarized features and advantages. Indeed, those skilled in the art will recognize additional features and advantages upon reading the following detailed description, and upon viewing the accompanying drawings.

Advantages of the embodiments described above are e.g. that adjustment of the amount of interference averaging that the UE performs for CSI reporting is allowed, so that it corresponds to what is suitable for the situation at hand. CoMP and non-CoMP operation typically have different demands on the amount of averaging and the invention allows the network and the user terminal to adjust for that. In general, the techniques allow the network to control the averaging of interference measurements e.g. depending on the scheduling strategy of the network. The signaling mechanisms being proposed are especially efficient since they to a large degree reuse existing signaling with intelligent ways to identify when more or less averaging is needed. Furthermore, the techniques allow reducing or even removing inconsistent behavior of UEs operating in the same network and hence allow for optimized setup of outer-loop-link adaptation (OLLA) control, which will ensure high performance.

### Details of Embodiments

As noted above, new functionality is introduced in LTE Release 11, whereby the network will be able to configure a UE to measure interference on a particular IMR. The IMR identifies a particular set of REs in the time and frequency grid that is to be used for a corresponding interference measurement. The network can thus control the interference seen on an IMR, by, for example, muting all TPs within a coordination cluster on the IMR, in which case the UE will effectively measure the inter-CoMP cluster interference. Moreover, it is essential that an eNodeB can accurately evaluate the performance of a UE given different CoMP transmission hypotheses; otherwise the dynamic coordination becomes meaningless. Thus, the system must also be able to track or estimate different intra-cluster interference levels corresponding to different transmission and blanking hypotheses.

An important aspect to consider when the network is configured with multiple IMRs, each corresponding to an interference hypothesis, is that the likelihood that the different interference hypotheses are actually realized in a downlink transmission varies between different hypotheses depending on the system load. For instance, in a highly loaded system it is less likely that all TPs within a coordination cluster are muted, simply because muting is costly, compared to when the network load is low. Moreover, in many cases the network can make a qualified guess, based on, e.g., Received Signal Reference Power (RSRP) measurements, that two interference hypotheses for some specific UE result in similar performance. This may e.g. be true if they only differ in transmissions from relatively weak TPs. In order to reduce system complexity, in particular feedback overhead, the network can decide to approximate one such IMR by its similar counterpart. A consequence of the above observations is that the importance of receiving CSI based on a specific IMR varies from UE to UE, and the importance also depends on the overall traffic situation in the system. For each UE, the network may order the IMRs in a priority list, where some IMRs are more important to include in the CSI reporting than others. This priority allows the network to reduce the amount of CSI reporting without compromising on quality.

Using the techniques described herein, a network can control the amount of averaging the UE is using, or the maximum averaging the UE is allowed to use, when forming the interference estimate for a certain report. Let A and B represent two different amounts of interference averaging, maximally allowed interference averaging, or ranges of allowed interference averaging, that the network selects between. Obviously more levels could be considered with straightforward generalizations of the concepts disclosed herein. Without loss of generality, henceforth in this disclosure it is assumed that averaging amount A corresponds to more interference averaging than averaging amount B. The interference averaging amount A could be geared towards non-CoMP operation, for which the interference changes in a rather unpredictable way and for which it may thus be useful to increase the averaging so that an average interference level over a larger region in the time-frequency plane is obtained. Correspondingly, the averaging amount B would be suitable for CoMP, where it is beneficial to reduce the amount of averaging so that the interference estimate reflects an interference snapshot that is well confined in time and frequency.

The actual averaging operation in the UE can be performed in many different ways, using various filters such as Finite Impulse Response (FIR) filters or Infinite Impulse Response (IIR) filters, or a combination thereof, where parameters in those filters control the amount of averaging. The filter coefficients, as well as the span of the filter in the time-frequency domain, determine the effective averaging amount. A simple filter would entail a linear moving average. The time span of a filter may involve subframes of relevant IMR REs, relevant in the sense that they correspond to the CSI process of interest, that do not occur after, or substantially after, the corresponding CSI reference resource. The time span could be limited to the M last such subframes, for example in case of FIR filters. In the frequency domain, the filter or averaging could be limited to the relevant IMR REs falling within the frequencies of the CSI reference resource, i.e., the subband corresponding to said resource. A larger time-frequency span of the filter provides the possibility for a larger amount of averaging.

An important special case of controlling the amount of averaging is to explicitly control the set of relevant IMR REs the UE is allowed to use or is using for an interference estimate. Thus, the averaging amount A could correspond to a larger set of such IMR REs, possibly corresponding to using a large time and/or frequency span of a filter while averaging amount B correspond to a smaller set of IMR REs potentially implemented using a filter with a smaller time and/or frequency span. Averaging amount B can, for example, correspond to the IMR REs within a single subframe and/or within the frequencies in a single subband, while averaging amount A can use IMR REs from multiple subframes, but possibly still within the frequencies of a single subband.

The amount of averaging can be signaled from the network to the UE in various ways. In one exemplary embodiment the use of CoMP or non-CoMP for a UE is used to determine the amount of averaging. So if the UE is deemed to be operating in CoMP conditions, an averaging amount B is used while in the case of non-CoMP an averaging amount A is used. It would be particularly interesting to use an averaging amount B that is specified in terms of an averaging time-frequency region. Furthermore, that time-frequency region is within the relevant IMR REs in the latest single subframe containing the IMR REs that occurs before or in the subframe containing the CSI reference resource, and where that time-frequency region is within frequencies of the single subband corresponding to the CSI reference resource. Similarly, averaging amount A could be in terms of an averaging time-frequency region that is within a single subband but allows averaging over multiple subframes containing IMR REs.

### Implicit Signaling Using CSI Reporting Configuration Information

### Number of CSI Processes

One good way of distinguishing between CoMP and non-CoMP operation for a UE is to base it on the number of CSI processes for CSI feedback the UE is configured by the network to use. For example, the UE is instructed to use the averaging amount A if it is configured with a single CSI process and B if it is configured with more than one CSI process. Note that the switching point between A and B could be at a higher number of CSI processes than one.

### Rank Inheritance

In another exemplary embodiment, the averaging amount is determined based on whether so-called rank inheritance is configured or not for at least one CSI process. Rank inheritance is a feature in Rel-12 that instructs the UE to inherit the rank value for a CSI process from the rank determined in another CSI process. This is typically used in some CoMP operations where it is important that multiple CSI processes share the same rank value. So if rank inheritance is configured, for example, all CSI reporting uses averaging amount B, while if it is not configured averaging amount A is used. An alternative is that only the CSI processes involved in rank inheritance are using averaging amount B, while any remaining CSI processes are using averaging amount A.

### CSI Process Index

The averaging amount could also be tied to one of the CSI processes. For example, the CSI process with the lowest index, e.g. the first CSI process, could be using averaging amount A while remaining CSI processes, if configured, could be using averaging amount B.

### Type of CSI Reporting

The type of CSI reporting may also be used for signaling the amount of averaging. Aperiodic reports could be using an averaging amount B while periodic reports could be using an amount A. This is motivated by the typically long periods configured for periodic reporting that anyway prevents the reports from tracking the dynamics of the interference level, thus making it reasonable to aim for average interference levels. Furthermore, the dynamically triggered aperiodic reporting has a greater chance of tracking dynamically changing interference variations and thus would benefit from more instantaneous interference levels.

### Periodicity of CSI Reporting

Related to the previous embodiment is an example where the averaging amount would be linked to the periodicity of the periodic reporting incase the CSI reports is associated with a periodic CSI feedback mode. So, averaging amount A could correspond to a long period, while averaging amount B would correspond to a shorter period. A threshold could be used to distinguish between the two.

### Number of Antenna Ports

The number of antenna ports that is assumed for the CSI report could be yet another way to infer the averaging amount. For few antenna ports, e.g., two or less, averaging amount B could be used, and when there are more antenna ports an averaging amount A could instead be used. This tries to take into account that the flashlight effect due to beamforming or pre-coding becomes stronger when increasing the number of transmit antennas. As the interference becomes very dynamic when you have a large amount of antennas, it is better to have a higher averaging amount.

### PMI Reporting

The configuration of PMI or no-PMI/RI reporting could be another way to signal and distinguish between averaging amounts. When no-PMI/RI reporting is enabled, it is highly likely that reciprocity based schemes in TDD are used with many transmit antennas. Hence, an averaging amount A could be appropriate. On the other hand, if PMI reporting is enabled it would be better to use averaging amount B. The use of TDD and FDD could also be used as a distinguisher between what averaging amount to use.

### Implicit Signaling Using PQI Process Configuration Information

The configuration of PQI could also be used for inferring the averaging amount. PQI is signaled using two bits in DCI Format 2D, and controls a number of things for the associated PDSCH transmission. E.g. it controls the assumptions for the PDSCH mapping onto the RE grid, such as the ZP CSI-RS configuration, MBSFN configuration, PDSCH OFDM symbol starting position, and assumed CRS REs to map PDSCH around. It may also control the so-called quasi-co-location (QCL) info that informs the UEs of which antenna ports that may be assumed to share channel properties or partial channel properties. Various ways of exploiting the PQI to infer averaging amounts could be conceived. For example, the number of configured PQI states could be an indicator distinguishing the averaging amount. Alternatively, the number of different ZP CSI-RS configurations used in the PQI state could be an indicator, where one ZP CSI-RS configuration could correspond to averaging amount A and multiple ZP CSI-RS configurations could correspond to averaging amount B.

In embodiments of the invention, it may be possible to signal the amount of averaging to use for interference measurements by using the PQI state signaling. This is especially beneficial when only one CSI process is configured, as that makes it unlikely that multiple PQI states will be used. The PQI state signaling may instead be used for signaling an averaging scheme informing the user terminal about what averaging amount to use. The first PQI state could e.g. correspond to averaging amount A and the other PQI states could correspond to averaging amount B.

### Implicit Signaling Using Transmission Mode Configuration Information

In yet another exemplary embodiment the choice of transmission mode could be used as a way for the network to indicate to the UE the amount of interference averaging. For example, transmission modes 1 to 9 could be using an averaging amount A, potentially corresponding to an unrestricted observation region, while Transmission Mode 10 would be associated with an averaging amount B.

### Explicit Signaling

The previous exemplary embodiments are all concerned with reusing existing signaling mechanism for indicating to the UE what amount of interfering averaging to use or maximally use. Yet another alternative is to introduce new explicit signaling of the averaging amount. This could take the form of a higher layer message, such as an RRC or MAC element, or it could be a physical layer message, e.g. as part of a control channel. In one example it could be signaled together with the triggering of aperiodic CSI. The explicit signaling message would indicate to the UE to either use averaging amount A or B for some CSI reporting, or for all CSI reports or for a subset thereof. The explicit message could in particular indicate which IMR REs that the UE is allowed to use or should use, similarly to as in previously mentioned exemplary embodiments.

Although the presently disclosed techniques have mostly been described with the new Transmission Mode 10 in mind, these techniques may also be used in conjunction with other and previous transmission modes, including transmission modes 1-9. All the exemplary embodiments here should be applicable except the ones concerned with number of CSI process and rank inheritance, as there is no such functionality for the earlier transmission modes. Note also that in this case the use of IMR in the embodiments could be replaced with other resources to measure interference, including CRS REs.

Needless to say, elements from all the different examples mentioned above can be combined in different ways and these combinations are contemplated by the present disclosure. In particular, the signaling mechanism can infer an averaging amount from a combination of criteria listed in the description. Toward this end, a multitude of threshold values could be used in the multifold decision region formed by the various criteria. Also, the roles of averaging amount A and B could be interchanged so that averaging amount A would correspond to a smaller amount of averaging and B to a larger amount. The term averaging amount has in general been used as a general term encompassing interference measurement regions as well as actual use or various forms of allowed use.

In addition to letting the scheduling strategy determine the averaging amount, the network could also chooser an averaging amount based on parameters such as network load, traffic conditions such as traffic burstiness, packet length and arrival rate, and UE mobility.

### Embodiments of Methods

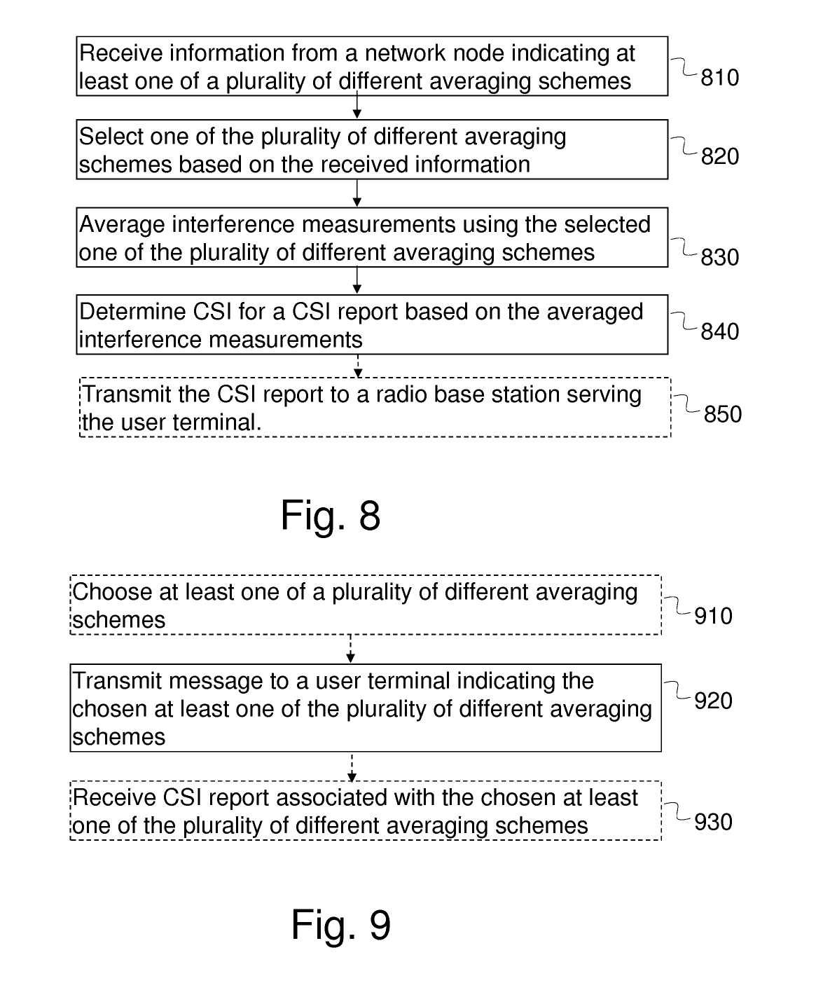

FIG. 8 is a flowchart illustrating an embodiment of a method for determining CSI. The method is suitable for implementation in a user terminal 10 of a wireless communication network. The method comprises:
810: Receiving information from a network node 20. The information indicates at least one of a plurality of different averaging schemes. Each averaging scheme within the plurality of different averaging schemes defines a limitation regarding over which radio resources averaging is allowed for interference measurements. The averaging schemes may thus e.g. correspond to the averaging amounts A and B described previously. The limitation regarding over which radio resources that averaging is allowed may be at least one of: a maximum amount of radio resources over which averaging is allowed; a minimum amount of radio resources over which averaging is allowed; and defined radio resources over which averaging is allowed. A combination of a maximum and a minimum amount of radio resources would thus correspond to a range defining possible amounts of radio resources over which averaging is allowed. The radio resources may be frequency resources and/or time resources. The radio resources may e.g. be one or many subframes in time and one or many RBs in frequency. In one embodiment, the radio resources—over which averaging is allowed—comprise only radio resources configured as IMR.
820: Selecting one of a plurality of different averaging schemes based on the received information.
830: Averaging interference measurements using the selected one of the plurality of different averaging schemes.
840: Determining CSI for a CSI report based on the averaged interference measurements. The CSI may e.g. comprise a CQI.
850 (optional): Transmitting the CSI report to a radio base station serving the user terminal 10. As explained in the background section, the CSI feedback assists the radio base station in scheduling.

In embodiments of the invention, and as already described previously, the information indicating one or more of the plurality of different averaging schemes may comprise an explicit indication of an averaging scheme, such as a new message dedicated for the purpose of indicating a certain averaging scheme to the user terminal. It may also be a new information element in an existing signaling message. Furthermore, it may be a higher layer message such as an RRC or MAC element, or it may be a physical layer message. Alternatively, or in addition to the explicit message, the received information may comprise an implicit indication of an averaging scheme e.g. configuration information related to CSI reporting that implicitly makes it clear to the user terminal that a certain averaging scheme should be used when it performs its averaging measurements for creating a CSI report. An explicitly signaled message that indicates two averaging schemes may e.g. be combined with signaling of configuration information that implicitly indicates which one of the two explicitly signaled averaging schemes to select for averaging interference measurements. The combination of the explicit message and the implicit configuration information may thus uniquely identify which averaging scheme to use.

In a first embodiment of the method in the user terminal, covering the explicit signaling, the received information indicating at least one of the plurality of different averaging schemes comprises a message indicating at least one of the plurality of different averaging schemes to use for determining the CSI. In a second embodiment of the method in the user terminal, covering the implicit signaling, the received information indicating at least one of the plurality of different averaging schemes comprises configuration information indicating at least one of the plurality of different averaging schemes. In embodiments of the invention, the configuration information may comprise at least one of CSI reporting configuration information, PQI process configuration information, and transmission mode configuration information. The CSI reporting configuration information may comprise at least one of the following parameters:
a number of CSI processes used for CSI feedback,
a rank inheritance configuration,
an index of a CSI process,
a type of CSI reporting where the type is aperiodic or periodic,
a periodicity of periodic CSI reporting,
a number of antenna ports configured for CSI reporting,
a precoding matrix indicator reporting configuration for the CSI feedback.

A combination of parameters related to CSI reporting configuration information is thus possible, as well as a combination of parameters related to CSI reporting configuration information and parameters related to e.g. PQI process configuration information.

FIG. 9 is a flowchart illustrating an embodiment of a method for controlling averaging of interference measurements. The method is suitable for implementation in a network node 20 of a wireless communication network. The method comprises:
910 (optional): Choosing at least one of a plurality of different averaging schemes. Each averaging scheme within the plurality of different averaging schemes defines a limitation regarding over which radio resources averaging is allowed for interference measurements. The limitation regarding over which radio resources averaging is allowed is at least one of a maximum amount of radio resources over which averaging is allowed; a minimum amount of radio resources over which averaging is allowed; and defined radio resources over which averaging is allowed. The radio resources may be frequency resources and/or time resources. In one embodiment, the radio resources—over which averaging is allowed—comprise only radio resources configured as IMR. The one or more of the plurality of different averaging schemes may be chosen based on at least one of: a network scheduling strategy, a network load, traffic conditions, and a mobility situation of the user terminal. In addition or alternatively, the at least one of the plurality of different averaging schemes may be chosen based on configuration information. The configuration information may comprise CSI reporting configuration information, PQI process configuration information, and/or transmission mode configuration information. The CSI reporting configuration information may comprise the parameters detailed in the list of parameters given above in the description of the user terminal method.
920: Transmitting a message to a user terminal 10. The message indicates at least one of a plurality of different averaging schemes chosen by the network node 10. The message is transmitted to control the averaging of interference measurements performed by the user terminal 10 when determining CSI.

### Details of User Terminal Method

In embodiments of the invention, the method comprises selecting one of a plurality of averaging schemes to be used for averaging interference measurements. The method further comprises determining a CSI report based on the selected averaging scheme. In some embodiments, there may be only two averaging schemes, e.g., averaging amount A and averaging amount B described above, but other embodiments may provide for more than two.

One or more of the averaging schemes may be applicable to only the averaging of IMR REs. In other embodiments, the averaging scheme may be alternatively applicable to other RSs, or additionally applicable to other RSs. In some embodiments, the applicability of the averaging scheme to RSs may depend on the transmission mode, such as whether or not the user terminal is using Transmission Mode 10 as specified by the LTE specifications.

In several embodiments, the selecting of the averaging scheme is based on configuration information, which configuration information may be signaled to the user terminal by the network. For example, in some embodiments, the averaging scheme is selected based on whether or not CoMP is used. Thus, for example, a first averaging scheme is used if CoMP is used, while a second averaging scheme is used otherwise. In some of these embodiments, the averaging scheme used when CoMP is used may confine the averaging scheme to RSs in a single subframe, or to within a particular subband, while the averaging scheme used otherwise may comprise averaging across several subframes and/or across a larger subband. In some embodiments, the selecting of the averaging scheme is based on the transmission mode used by the user terminal. For instance, a first averaging scheme may be selected for transmission modes 1 to 9, while a second averaging scheme is selected for transmission mode 10. Similarly, the selected averaging scheme may depend on the number of antenna ports assumed for the report, in some embodiments. Likewise, the averaging scheme may depend on the configuration of PMI reporting, and/or on the configuration of Physical downlink shared channel mapping and Quasi co-location Information (PQI). In some embodiments, the averaging scheme may depend on whether TDD or FDD mode is being used. In some embodiments, the selecting of the averaging scheme may depend on the number of CSI processes that the user terminal is configured to use. In some embodiments, the selecting of the averaging scheme may depend on whether or not rank inheritance is configured for at least one CSI process. In some embodiments, the user terminal may apply different averaging schemes to different CSI processes, e.g., depending on whether or not rank inheritance is configured for each process. In some embodiments, the user terminal may apply different averaging schemes to different CSI processes, where the selection of the averaging scheme for a given CSI process depends on an index for the process. In still other embodiments, the selecting of the averaging scheme may depend on the type of CSI report, such as whether the CSI report is a periodic or aperiodic. Thus, for example, a first averaging scheme may be used for periodic reports, while a second averaging scheme is used for aperiodic reports. Similarly, in some embodiments the selecting of the averaging scheme may depend on the length of the period for periodic CSI reporting.

It will be appreciated that the selecting of the averaging scheme may depend on a combination of two or more of the configuration parameters described above, or a combination of any of the above parameters with one or more other parameters. Furthermore, in some embodiments the user terminal may base the selection of the averaging scheme on explicit signaling from the network, alone or in combination with one or more of the configuration parameters described above. Thus, the user terminal may receive signaling from the network, in some embodiments, the signaling indicating an averaging scheme to be used. This operation may not occur in every embodiment or under all circumstances. The explicit signaling may indicate a particular amount of averaging to use, in some embodiments, e.g., in terms of particular REs to be used and/or in terms of a number of subframes and/or a quantity of frequency resources to be used for such averaging. In some embodiments, the user terminal may be configured to select an averaging scheme based on one or more of the configuration parameters described above in the absence of explicit signaling, while following the explicit signaling when it is present.

### Details of Network Node Method

Other embodiments of the techniques described comprise corresponding methods suitable for implementation in a base station or other controlling node in a wireless communication system. In an example method, the base station or other controlling node chooses one of a plurality of averaging schemes to be used for averaging interference measurements by a given user terminal. The base station or other controlling node then transmits signaling information indicating the chosen averaging scheme to the user terminal. In some embodiments, there may be only two averaging schemes, e.g., averaging amount A and averaging amount B, but other embodiments may provide for more than two.

In various embodiments, the choosing of the averaging scheme by the base station or other controlling node may be based on one or more of the configuration parameters discussed above. In some embodiments, the choosing of the averaging scheme may be based on one or more network conditions or traffic conditions, such as a network load, traffic burstiness, packet length, and/or packet arrival rate, or on user terminal mobility. The choosing of the averaging scheme may be based on a combination of two or more of these conditions and/or a combination of one or more of these conditions with one or more of the configuration parameters mentioned above, in some embodiments.

### Embodiments of Apparatus

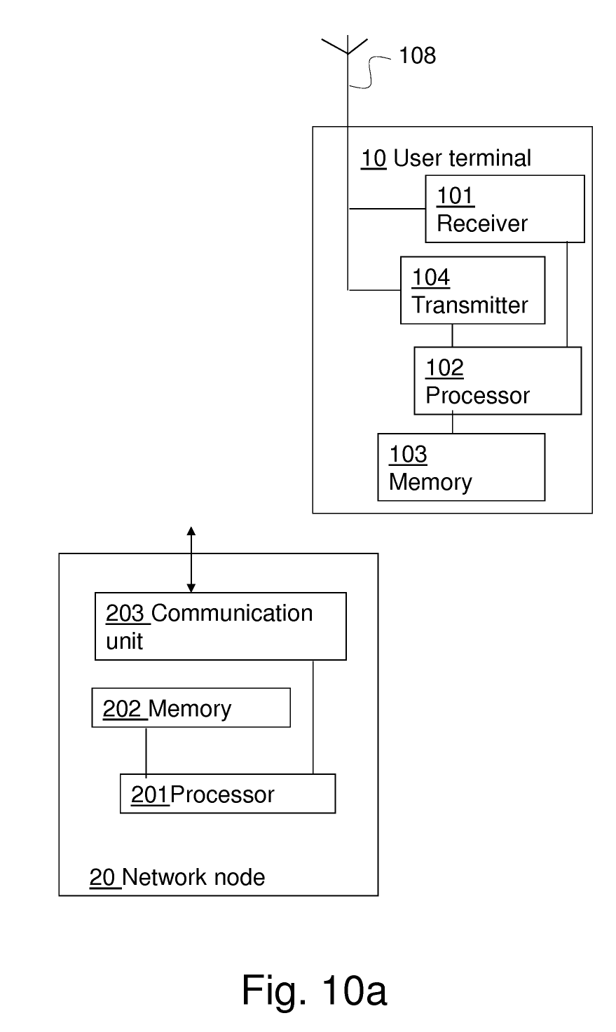

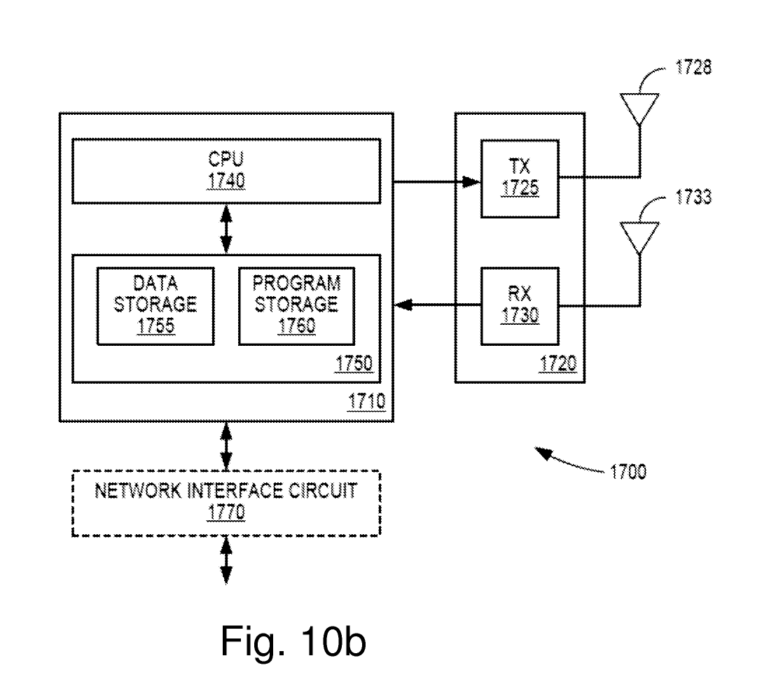

It will be appreciated that corresponding apparatus embodiments adapted to carry out these methods, i.e., UE/user terminal apparatus, and network node apparatus such as base station (e.g., eNodeB) apparatus and control node apparatus, follow directly from the above. More particularly, it will be appreciated that the functions in the techniques and methods described above may be implemented using electronic data processing circuitry provided in user terminals, base stations, and other network nodes in a radio communication network. Each user terminal and base station, of course, also includes suitable radio circuitry for receiving and transmitting radio signals formatted in accordance with known formats and protocols, e.g., LTE formats and protocols. Embodiments of a user terminal 10 and a network node 20 of a wireless communication network are schematically illustrated in the block diagram in FIG. 10a.

The user terminal 10 is configured to determine CSI, and comprises a receiver 101, a processor 102, and a memory 103. The receiver may be connected to one or more antennas 108. The memory contains instructions executable by the processor, whereby the user terminal is operative to receive information from a network node via the receiver, the information indicating at least one of a plurality of different averaging schemes, select one of the plurality of different averaging schemes based on the received information, average interference measurements using the selected one of the plurality of different averaging schemes, and determine CSI for a CSI report based on the averaged interference measurements. Each averaging scheme within the plurality of different averaging schemes defines a limitation regarding over which radio resources averaging is allowed for interference measurements. The limitation regarding over which radio resources averaging is allowed is at least one of a maximum amount of radio resources over which averaging is allowed; a minimum amount of radio resources over which averaging is allowed; and defined radio resources over which averaging is allowed. The radio resources may be frequency resources and/or time resources. In one embodiment, the radio resources—over which averaging is allowed—comprise only radio resources configured as IMR.

In a first embodiment of the user terminal, covering the explicit signaling, the received information indicating at least one of the plurality of different averaging schemes comprises a message indicating at least one of the plurality of different averaging schemes to use for determining the CSI. In a second embodiment of the user terminal covering the implicit signaling, the received information indicating at least one of the plurality of different averaging schemes comprises configuration information indicating at least one of the plurality of different averaging schemes.

In embodiments of the invention, the configuration information may comprise at least one of CSI reporting configuration information, PQI process configuration information, and transmission mode configuration information, in accordance with the embodiments described above. The CSI reporting configuration information may comprise at least one of the following parameters:
a number of CSI processes used for CSI feedback,
a rank inheritance configuration,
an index of a CSI process,
a type of CSI reporting where the type is aperiodic or periodic,
a periodicity of periodic CSI reporting,
a number of antenna ports configured for CSI reporting,
a precoding matrix indicator reporting configuration for the CSI feedback.

In embodiments, the user terminal 10 may further comprise a transmitter 104, and the memory 103 may further contain instructions executable by said processor whereby the user terminal is operative to transmit the CSI report via the transmitter to a radio base station serving the user terminal. The radio base station may correspond to the network node 20.

The network node 20 in FIG. 10a is configured to control averaging of interference measurements. The network node comprises a communication unit 203, a processor 201, and a memory 202. The network node may be a base station or some other network node controlling the averaging. When the network node is a base station, the communication unit 203 may comprise a transceiver for communicating wirelessly with the user terminal. For other network nodes, the communication unit 203 enables communication with the user terminal via a base station. The memory 202 contains instructions executable by the processor 201 whereby the network node is operative to transmit a message via the communication unit 203 to a user terminal 10. The message indicates at least one of a plurality of different averaging schemes chosen by the network node. This is done to control the averaging of interference measurements performed by the user terminal when determining CSI. Each averaging scheme within the plurality of different averaging schemes defines a limitation regarding over which radio resources that averaging is allowed for interference measurements. The limitation regarding over which radio resources averaging is allowed is at least one of a maximum amount of radio resources over which averaging is allowed; a minimum amount of radio resources over which averaging is allowed; and defined radio resources over which averaging is allowed. The radio resources may be frequency resources and/or time resources. In one embodiment, the radio resources—over which averaging is allowed—comprise only radio resources configured as IMR.

In embodiments, the memory further contains instructions executable by the processor whereby the network node is operative to choose at least one of the plurality of different averaging schemes. The information transmitted to the user terminal thus indicates the chosen at least one of the plurality of different averaging schemes. The choice of averaging scheme may be based on at least one of: a network scheduling strategy, a network load, traffic conditions, and a mobility situation of the user terminal. In addition or alternatively, the choice may be based on configuration information comprising CSI reporting configuration information as detailed in the list of parameters given above in the description of the user terminal apparatus, PQI process configuration information, and/or transmission mode configuration information.

In an alternative way to describe the embodiment in FIG. 10a, the user terminal comprises means for receiving information from a network node. The means for receiving may typically be a receiver of the user terminal connected to one or more antennas. Further, the user terminal comprises means for selecting one of a plurality of different averaging schemes based on the received information, where each averaging scheme within the plurality of different averaging schemes defines a limitation regarding over which radio resources averaging is allowed for interference measurements. The user terminal also comprises means for averaging interference measurements using the selected one of the plurality of different averaging schemes, and means for determining CSI for a CSI report based on the averaged interference measurements. The network node comprises means for transmitting a message to a user terminal. The message indicates at least one of a plurality of different averaging schemes chosen by the network node, to control the averaging of interference measurements performed by the user terminal when determining CSI. Each averaging scheme within the plurality of different averaging schemes defines a limitation regarding over which radio resources averaging is allowed for interference measurements. The means for transmitting typically corresponds to a transmitter connected to one or more antennas when the network node is a base station. The means described above are functional units which may be implemented in hardware, software, firmware or any combination thereof. In one embodiment, the means are implemented as a computer program running on a processor.

FIG. 10b illustrates features of an example communications node 1700 according to several embodiments of the presently disclosed techniques. Although the detailed configuration, as well as features such as physical size, power requirements, etc., will vary, the general characteristics of the elements of communications node 1700 are common to both a wireless base station and a user terminal. Either may be adapted to carry out one or several of the techniques described above for supporting transmission of broadcast messages in a radio communications network.

Communications node 1700 comprises a transceiver 1720 for communicating with mobile terminals (in the case of a base station) or with one or more base stations (in the case of a mobile terminal) as well as a processing circuit 1710 for processing the signals transmitted and received by the transceiver 1720. Transceiver 1720 includes a transmitter 1725 coupled to one or more transmit antennas 1728 and receiver 1730 coupled to one or more receive antennas 1733. The same antenna(s) 1728 and 1733 may be used for both transmission and reception. Receiver 1730 and transmitter 1725 use known radio processing and signal processing components and techniques, typically according to a particular telecommunications standard such as the 3GPP standards for LTE and/or LTE-Advanced. In the event that communications node 1700 is a base station, it may further comprise a network interface circuit 1770, which network interface circuit 1770 is adapted to communicate with other network nodes, such as an MME or other control node, using industry-defined protocols such as the S1 interface defined by 3GPP. Because the various details and engineering trade-offs associated with the design and implementation of transceiver circuitry, processing circuitry, and network interface circuitry are well known and are unnecessary to a full understanding of the presently disclosed techniques and apparatus, additional details are not shown here.

Processing circuit 1710 comprises one or more processors 1740, hardware, firmware or a combination thereof, coupled to one or more memory devices 1750 that make up a data storage memory 1755 and a program storage memory 1760. Memory 1750 may comprise one or several types of memory such as read-only memory (ROM), random-access memory, cache memory, flash memory devices, optical storage devices, etc. Again, because the various details and engineering trade-offs associated with the design of baseband processing circuitry for mobile devices and wireless base stations are well known and are unnecessary to a full understanding of the presently disclosed techniques and apparatus, additional details are not shown here.

Typical functions of the processing circuit 1710 include modulation and coding of transmitted signals and the demodulation and decoding of received signals. In several embodiments, processing circuit 1710 is adapted, using suitable program code stored in program storage memory 1760, for example, to carry out one or several of the techniques described above. Of course, it will be appreciated that not all of the steps of these techniques are necessarily performed in a single microprocessor or even in a single module. Thus, embodiments of the presently disclosed techniques include computer program products for application in a user terminal as well as corresponding computer program products for application in a base station apparatus.

It will be appreciated by the person of skill in the art that various modifications may be made to the above described embodiments without departing from the scope of the present invention. For example, it will be readily appreciated that although the above embodiments are described with reference to parts of a 3GPP network, an embodiment of the present invention will also be applicable to like networks, such as a successor of the 3GPP network, having like functional components. Therefore, in particular, the terms 3GPP and associated or related terms used in the above description and in the enclosed drawings and any appended claims now or in the future are to be interpreted accordingly.

Examples of several embodiments of the present invention have been described in detail above, with reference to the attached illustrations of specific embodiments. Because it is not possible, of course, to describe every conceivable combination of components or techniques, those skilled in the art will appreciate that the present invention can be implemented in other ways than those specifically set forth herein, without departing from essential characteristics of the invention. The present embodiments are thus to be considered in all respects as illustrative and not restrictive.

1-22. (canceled)

23. A method for determining channel state information, CSI, the method being suitable for implementation in a user terminal of a wireless communication network and comprising:
receiving information from a network node, the information indicating at least one of a plurality of different averaging schemes, each averaging scheme within the plurality of different averaging schemes defining a limitation regarding over which radio resources averaging is allowed for interference measurements,
selecting one of the plurality of different averaging schemes based on the received information,
averaging interference measurements using the selected one of the plurality of different averaging schemes, and
determining CSI for a CSI report based on the averaged interference measurements.

24. The method according to claim 23, wherein the information indicating at least one of the plurality of different averaging schemes comprises a message indicating at least one of the plurality of different averaging schemes to use for determining the CSI.

25. The method according to claim 23, wherein the information indicating at least one of the plurality of different averaging schemes comprises configuration information indicating at least one of the plurality of different averaging schemes.

26. The method according to claim 25, wherein the configuration information comprises at least one of CSI reporting configuration information, Physical downlink shared channel mapping and Quasi co-location Information process configuration information, and transmission mode configuration information.

27. The method according to claim 23, further comprising:
transmitting the CSI report to a radio base station serving the user terminal.

28. The method according to claim 23, wherein the limitation regarding over which radio resources averaging is allowed is at least one of a maximum amount of radio resources over which averaging is allowed; a minimum amount of radio resources over which averaging is allowed; and defined radio resources over which averaging is allowed.

29. The method according to claim 23, wherein the radio resources are frequency resources and/or time resources.

30. The method according to claim 23, wherein the radio resources over which averaging is allowed comprise only radio resources configured as interference measurement resources.

31. A method for controlling averaging of interference measurements, the method being suitable for implementation in a network node of a wireless communication network, the method comprising:
transmitting a message to a user terminal, the message indicating at least one of a plurality of different averaging schemes chosen by the network node, to control the averaging of interference measurements performed by the user terminal when determining channel state information, CSI, wherein each averaging scheme within the plurality of different averaging schemes defines a limitation regarding over which radio resources averaging is allowed for interference measurements.

32. The method according to claim 31, further comprising:
choosing at least one of the plurality of different averaging schemes, wherein the message transmitted to the user terminal indicates the chosen at least one of the plurality of different averaging schemes.

33. The method according to claim 31, wherein the at least one of the plurality of different averaging schemes is chosen based on at least one of: CSI reporting configuration information, Physical downlink shared channel mapping and Quasi co-location Information process configuration information, transmission mode configuration information, a network scheduling strategy, a network load, traffic conditions, and a mobility situation of the user terminal.

34. The method according to claim 31, wherein the network node is a radio base station serving the user terminal, the method further comprising:
receiving a CSI report from the user terminal, the CSI report being associated with the chosen at least one of the plurality of different averaging schemes.

35. The method according to claim 33, wherein the CSI reporting configuration information comprises at least one of the following parameters:
a number of CSI processes used for CSI feedback,
a rank inheritance configuration,
an index of a CSI process,
a type of CSI reporting where the type is aperiodic or periodic,
a periodicity of periodic CSI reporting,
a number of antenna ports configured for CSI reporting,
a precoding matrix indicator reporting configuration for the CSI feedback.

36. The method according to claim 31, wherein the limitation regarding over which radio resources averaging is allowed is at least one of a maximum amount of radio resources over which averaging is allowed; a minimum amount of radio resources over which averaging is allowed; and defined radio resources over which averaging is allowed.

37. The method according to claim 31, wherein the radio resources are frequency resources and/or time resources.

38. The method according to claim 31, wherein the radio resources over which averaging is allowed comprise only radio resources configured as interference measurement resources.

39. A user terminal of a wireless communication network for determining channel state information, CSI, the user terminal comprising a receiver, a processor, and a memory, said memory containing instructions executable by said processor, wherein said user terminal is configured to:
receive information from a network node via the receiver, the information indicating at least one of a plurality of different averaging schemes, each averaging scheme within the plurality of different averaging schemes defining a limitation regarding over which radio resources averaging is allowed, for interference measurements,
select one of the plurality of different averaging schemes based on the received information,
average interference measurements using the selected one of the plurality of different averaging schemes, and
determine CSI for a CSI report based on the averaged interference measurements.

40. The user terminal according to claim 39, wherein the information indicating at least one of the plurality of different averaging schemes comprises a message indicating at least one of the plurality of different averaging schemes to use for determining the CSI.

41. The user terminal according to claim 39, wherein the information indicating at least one of the plurality of different averaging schemes comprises configuration information indicating at least one of the plurality of different averaging schemes.

42. The user terminal according to claim 39, further comprising a transmitter, said memory further containing instructions executable by said processor whereby said user terminal is operative to:
transmit the CSI report via the transmitter to a radio base station serving the user terminal.

43. A network node of a wireless communication network for controlling averaging of interference measurements, the network node comprising a communication unit, a processor, and a memory, said memory containing instructions executable by said processor, wherein said network node is configured to:
transmit a message via the communication unit to a user terminal, the message indicating at least one of a plurality of different averaging schemes chosen by the network node, to control the averaging of interference measurements performed by the user terminal when determining channel state information, CSI, wherein each averaging scheme within the plurality of different averaging schemes defines a limitation regarding over which radio resources averaging is allowed for interference measurements.

44. The network node according to claim 43, said memory further containing instructions executable by said processor whereby said network node is operative to:
choose at least one of the plurality of different averaging schemes, wherein the message transmitted to the user terminal indicates the chosen at least one of the plurality of different averaging schemes.

45. The network node according to claim 43, wherein the network node is a radio base station serving the user terminal, said memory further containing instructions executable by said processor whereby said network node is operative to:
receive a CSI report from the user terminal via the communication unit, the CSI report being associated with the chosen at least one of the plurality of different averaging schemes.

46. A user terminal of a wireless communication network for determining channel state information, CSI, the user terminal comprising:
means for receiving information from a network node, the information indicating at least one of a plurality of different averaging schemes, each averaging scheme within the plurality of different averaging schemes defining a limitation regarding over which radio resources averaging is allowed for interference measurements,
means for selecting one of a plurality of different averaging schemes based on the received information,
means for averaging interference measurements using the selected one of the plurality of different averaging schemes, and
means for determining CSI for a CSI report based on the averaged interference measurements.

47. A network node of a wireless communication network for controlling averaging of interference measurements, the network node comprising:
means for transmitting a message to a user terminal, the message indicating at least one of a plurality of different averaging schemes chosen by the network node, to control the averaging of interference measurements performed by the user terminal when determining channel state information, CSI, wherein each averaging scheme within the plurality of different averaging schemes defines a limitation regarding over which radio resources averaging is allowed for interference measurements.
